(19) United States
(12) Patent Application Publication
(10) Pub. No.: US 2022/0410163 A1
(43) Pub. Date: Dec. 29, 2022

(54) ARRAY DROPLET MANIPULATIONS

(71) Applicant: HEWLETT-PACKARD DEVELOPMENT COMPANY, L.P., Spring, TX (US)

(72) Inventors: Michael W. Cumbie, Corvallis, OR (US); Viktor Shkolnikov, Palo Alto, CA (US); Chien-Hua Chen, Corvallis, OR (US)

(73) Assignee: HEWLETT-PACKARD DEVELOPMENT COMPANY, L.P., Spring, TX (US)

(21) Appl. No.: 17/778,517

(22) PCT Filed: Dec. 9, 2019
(86) PCT No.: PCT/US2019/065138

§ 371 Date: May 20, 2022

(51) Int. Cl. B01L 3/00

(52) U.S. Cl. CPC B01L 3/502792; B01L 2300/0663; B01L 2300/0645; B01L 2200/06; B01L 2400/0415; B01L 2200/16

(57) ABSTRACT

In one example an apparatus can include a controller communicatively coupled to a droplet dispenser to deposit fluid on a digital microfluidic (DMF) array including a plurality of droplet manipulation electrodes, the controller to: select a first droplet manipulation electrode from the plurality of droplet manipulation electrodes to on which to dispense a first volume of fluid via the droplet dispenser; position the droplet dispenser over the selected first droplet manipulation electrode; and deposit the first volume of fluid onto the selected first droplet manipulation electrode.

### BACKGROUND

Digital microfluidics systems may be used to perform a variety of chemical, biological, and biochemical processes by manipulating droplets of fluid. Fluids deposited on a microfluidics system can be moved and manipulated on a path across electrodes. In some systems, the manipulation of droplets includes movement of the droplets through various portions of the system, as well as treatment of the droplets with heat, magnetic fields or the like.

### BRIEF DESCRIPTION OF THE DRAWINGS

FIG. 1 is an example computing device and a digital microfluidic array for array droplet manipulations consistent with the present disclosure.

FIG. 2 is an example droplet dispenser and digital microfluidic array for array droplet manipulations consistent with the present disclosure.

FIG. 3 is another example droplet dispenser and digital microfluidic array for array droplet manipulations consistent with the present disclosure.

FIG. 4 is an example droplet dispenser and digital microfluidic array including a lid for array droplet manipulations consistent with the present disclosure.

FIG. 5 is another example droplet dispenser and digital microfluidic array including a lid for array droplet manipulations consistent with the present disclosure.

FIG. 6 is a block diagram for array droplet manipulations consistent with the present disclosure.

FIG. 7 is a block diagram for array droplet manipulations consistent with the present disclosure.

FIG. 8 is an example is a functional diagram representing a processing resource in communication with a memory resource having instructions written thereon for array droplet manipulations consistent with the present disclosure.

### DETAILED DESCRIPTION

Digital microfluidic (DMF) systems can be employed to implement a variety of analytical processes which can include fluid manipulations. DMF systems can include DMF arrays of electrodes that can be used to manipulate droplets to execute the analytical processes by physically moving droplets of fluid across the DMF array. Some analytical processes involve fluid manipulations such as the application of heat, the application of magnetic fields, combining fluids, etc. Some analytical processes involve sensing various properties of the fluid. The fluid manipulations for analytical processes can be implemented by elements in a DMF array such as heating circuits, sensing circuits, etc. Some DMF systems are fabricated as printed circuit boards (PCBs), with the above mentioned circuits implemented as traces on a PCB.

Reagents used in analytical processes can be prone to contamination as a fluid is moved on the DMF array. For reactions to occur during the analytical processes, reagents in the form of different droplets are brought together (e.g., merged) to coalesce and mix to initiate the reaction. As used herein, the term “merge” refers to a first fluid combining with another fluid. The droplets can be split so the product of the analytical process can be used in further (potentially combinatorial) reactions. Droplets can take a particular path on the DMF moving from a first electrode to subsequent electrodes. Moving droplets along a particular path can prevent other droplets from taking the particular path. This can limit the number of paths (e.g., the number of electrodes) of the DMF array that can be used by the droplets without risking contamination. Further, because some reagents can be more likely to cause contamination and/or be caustic, a number and type of reagents that can be mixed together by merging droplets and reagents can be limited.

The present disclosure relates to utilizing a computing device coupled to a droplet dispenser (e.g., an inkjet printhead) to deposit a volume of fluid from a reservoir coupled to the droplet dispenser onto a droplet manipulation electrode of a DMF array. As used herein, the term “reservoir” refers to a container capable of including a reagent within the container. The computing device can include a controller to align the droplet dispenser with a droplet manipulation electrode of the DMF array and deposit a reagent included in the coupled reservoir. As used herein, the term “droplet manipulation electrode” refers to an electrode of a DMF array that can alter, and/or manipulate a droplet and/or a volume of fluid deposited on the electrode of the DMF array.

The droplet dispenser can be equipped with sensors (e.g., camera, spectrometer, illuminance detection, temperature sensors, etc.). The droplet dispenser can use the sensors to determine an outcome of a reaction during an analytical process, align the droplet dispenser with a droplet manipulation electrode, and/or determine the status of reagent deposited on the droplet manipulation electrode (e.g., determine the completion of an analytical process), The droplet dispenser can be aligned to deposit droplets onto existing droplets, on droplet manipulation electrodes without an existing droplet, and/or a hydrophobic fluid. The droplet dispenser can align with a droplet manipulation electrode by detecting (via a computing device and/or controller) a change in the capacitance of the DMF array.

Examples of the present disclosure include the dynamic application of droplets from the droplet dispenser to the DMF array. For example, an analytical process can be initiated responsive to a reagent being deposited on a droplet manipulation electrode, and based on the outcome of the analytical process, the controller can align the droplet dispenser with a different droplet manipulation electrode to deposit a different reagent from a different reservoir.

In another example, the computing device can refrain from initiating another analytical process based on an outcome of a first analytical process and/or refrain from aligning the droplet dispenser with the different droplet manipulation electrode. Using droplet dispensers to deliver reagents to the DMF array can increase the number of analytical processes executed on an individual array by reducing a risk for contamination and increasing the variety of reagents available to perform analytical processes. Increasing the number of analytical processes executed on an individual array can provide a more efficient DMF array, reduce cost, and provide a greater variety of analytical processes offered.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense,

As used herein, designators such as “N,” “M,”, and “P,” etc., particularly with respect to reference numerals in the drawings, indicate that any quantity of the particular feature so designation can be included. It is also to be understood that the terminology used herein is for the purpose of describing particular examples only and is not intended to be limiting. As used herein, the singular forms “a,” “an,” and “the” can include both singular and plural referents, unless the context clearly dictates otherwise.

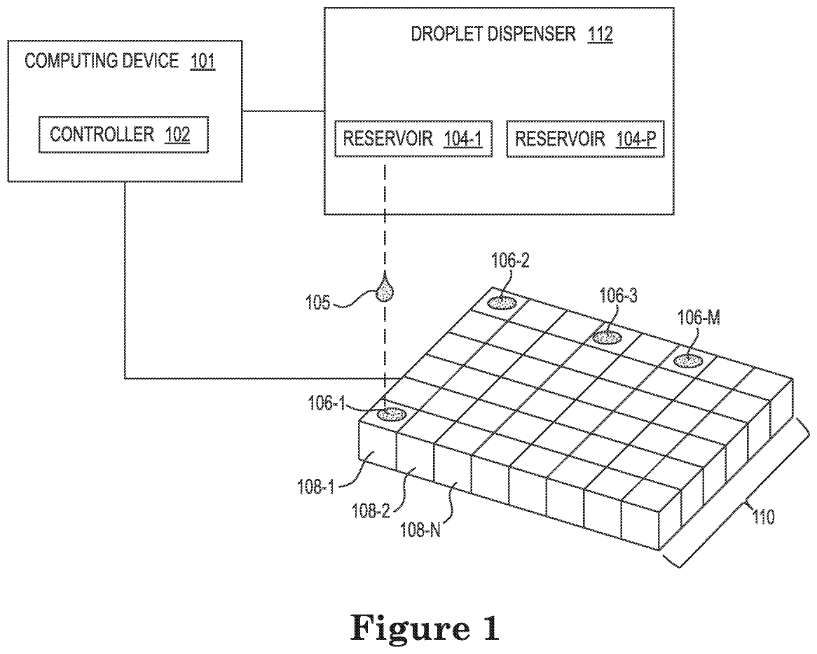

FIG. 1 is an example computing device 101 and a digital microfluidic array 110 for array droplet manipulations consistent with the present disclosure, FIG. 1 illustrates an example apparatus in the form of a computing device 101. The computing device 101 can include resources such as a processor and memory and a controller 102 can utilize the resources of the computing device 101 to perform particular functions, The controller 102 can be coupled to a droplet dispenser 112. The droplet dispenser 112 can include a plurality of reservoirs 104-1 to 104-P which can contain a fluid (e.g., a reagent for an analytical assay) to dispense a droplet 105. The droplet dispenser 112 can deposit the droplet 105 from a reservoir 104-1, 104-P, or both, as a volume of fluid 106-1, 106-2, 106-3, and/or 106-M onto a plurality of droplet manipulation electrodes 108-1,108-2, or 108-N of the DMF array 110.

The droplet manipulation electrodes 108-1, 108-2, and 108-N can be collectively referred to herein as the droplet manipulation electrodes 108 or the droplet manipulation electrode 108. Some of the droplet manipulation electrodes 108 of the DMF array 110 are not marked with an identifier as to not obscure examples of the disclosure. The volumes of fluid 106-1, 106-2, 106-3, and 106-M can be collectively referred to herein as volumes of fluid 106 or volume of fluid 106, The reservoirs 104-1 to 104-P can be collectively referred to herein as the reservoirs 104 or the reservoir 104. The reservoirs 104 can each contain the same fluids or different fluids. For example, the plurality of reservoirs 104 can be coupled to the droplet dispenser 112, wherein each of the plurality of reservoirs 104-1 to 104-N can contain a different fluid.

The volumes of fluid 106 can be volumes of fluid that are deposited on a droplet manipulation electrode 108 by the droplet dispenser 112 or be a volume of fluid that is already present on the droplet manipulation electrodes 108. For example, particular reagents can be deposited on droplet manipulation electrodes 108 when the DMF array 110 is manufactured or otherwise prepared. The particular reagents already present on the droplet manipulation electrodes 108 can be strategically positioned such that other volumes of fluid 106 can be merged with them during an analytical process.

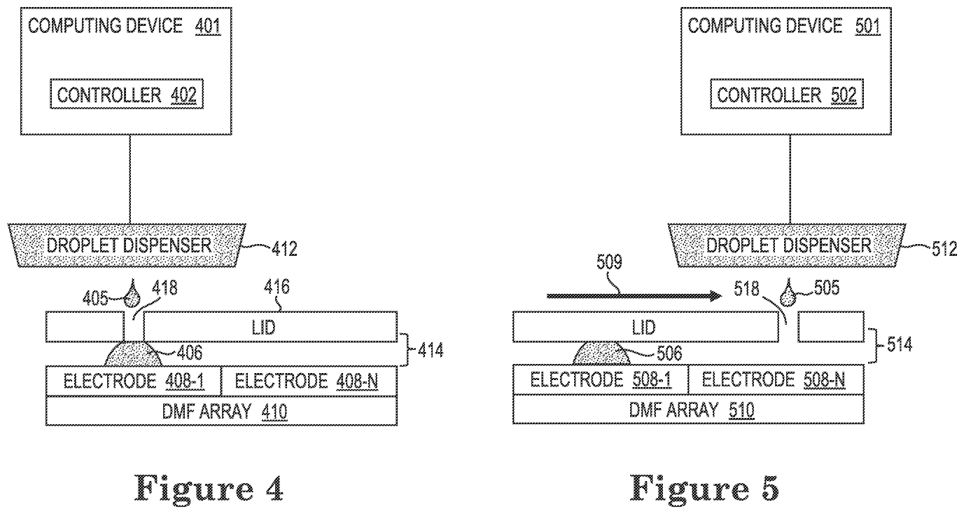

The DMF array 110 can be coupled to a power supply (not illustrated as to not obscure the examples of the disclosure). The power supply can be used to apply voltages to the droplet manipulation electrodes 108 of the DMF array 110. The droplet manipulation electrodes 108 of the DMF array 110 can be coated with a film to electrically insulate the volumes of fluid 106 from the droplet manipulation electrodes 108 and to provide a low friction surface for the volume of fluid 106. As will be discussed in connection with FIGS. 4 and 5, the DMF array 110 may be covered with an electrically grounded lid. The electrically grounded lid can cover the DMF array 110 intermittently (e.g., while the droplet dispenser 112 is not dispensing fluid), or the lid may be perforated with apertures such that a droplet 105 can traverse the lid.

The controller 102 can control the movement and operation the DMF array 110, the droplet dispenser 112, or both. The controller 102 can be a component of the computing device 101 such as a processor, an application specific integrated circuit (ASIC), a field programmable gate array (FPGA), a metal-programmable cell array (MPGA), or other combination of circuitry and/or logic configured to orchestrate execution of machine-readable instructions.

The droplet dispenser 112 can alter the droplet 105 to a particular volume to be deposited onto the droplet manipulation electrode 106 when instructed by the controller 102. For example, based on the analytical process, the droplet 105 can be customized by the droplet dispenser 112 to deposit a precise volume. Some analytical processes such as Polymerase Chain Reaction (e.g., PCR) utilize small volumes (e.g., pico, and/or micro liters). The controller 102 can move the droplet dispenser 112 to a position that is aligned with a droplet manipulation electrode 106. As mentioned herein, the droplet dispenser can be equipped with sensors to determine the alignment of the droplet dispenser 112 with the droplet manipulation electrode 108. The controller 102 can cause the DMF array 110 and/or the droplet dispenser 112 to move to align the droplet dispenser with a droplet manipulation electrode 106. For example, the droplet dispenser 112 can align with droplet manipulation electrode 108-1 to deposit droplet 105. The droplet 105 position can be confirmed by the controller 102 and the droplet dispenser 112 by measuring a capacitance of the particular droplet manipulation electrode 108-1 relative to neighboring droplet manipulation electrodes (e.g., 108-2).

The droplet dispenser 112 can be a modified inkjet printhead. In an example, this modified inkjet printhead is a thermal inkjet (TIJ) which uses a heating resistor to form an ejection bubble to propel a liquid droplet. In another example, the droplet dispenser 112 (e.g., the modified inkjet printhead) is a piezoelectric inkjet (PIJ) which uses a piezoelectric actuator to eject the droplet.

The computing device 101 and/or the controller 102 can cause the implementation of an analytical process via the generation of control signals for droplet manipulation electrodes. As mentioned, the DMF array 110 can move volumes of fluid 106 around the DMF array 110. For example, the controller 102 can cause a volume of fluid 106-1 to move from a first droplet manipulation electrode 108-1 to a second droplet manipulation electrode 108-2 (or to other droplet manipulation electrodes 108-N). In this example, an analytical process can be initialed on each of the droplet manipulation electrodes 108-1 and 108-2. In some examples described herein, the computing device 101 and/or the controller 102 can determine where on the DMF array 110 a volume of fluid 106 is to move based on the outcome of an analytical process executed on the droplet manipulation electrode 108.

The DMF array 110 can use principals such as electrowetting, dielectrophoretic, and/or immiscible-fluid flows to implement analytical processes which can be accomplished on a droplet manipulation electrode 108. The plurality of droplet manipulation electrodes 108 can implement the analytical processes by utilizing insulated elements (e.g., pads) in the DMF array 110 such as heating circuits, sensing circuits, magnetic fields, etc. For example, droplet manipulation electrodes 108 can include specialized pads to execute analytical processes or otherwise manipulate on the droplet 105 and/or volumes of fluid 106.

Examples of specialized pads include an electrode sensor with imbedded silicon integrated circuits (Si IC) for reaction monitoring and/or determining sample (e.g., droplet 105 and/or volume of fluid 106) concentration; a heater with integrated circuit controls for cell lysing, thermal cycling, and analytical process (e.g., reaction) control; a direct silicon contact for fluid sense, chemical analysis, optical detection, etc.; DMF aliquot pad with a local demultiplexer to partition droplets for use in multiple analytical processes, heating, and additional optical sensing; and/or DMF pads with embedded magnets for use in a magnetic particle trap which can be used for deoxyribonucleic acid (DNA) isolation, among other uses. A combination of specialized pads can be used on the DMF array 110 such that volumes of fluid 106 can be moved around the DMF array to execute various analytical processes.

Examples of analytical processes can include DNA isolation and/or extraction, polymerase chain reaction (PCR) including PCR variations such as digital PCR, droplet digital PCR, quantitative real-time PCR, etc., multiplexed cell-based assays (e.g., cell culture, transformation assays, heat shock vector transformation, etc.), chemical synthesis/analysis, among others. While particular analytical processes are discussed herein, others can be implemented.

Some reagents used in analytical processes can be caustic, reactive, highly susceptible to contamination, or otherwise difficult to manipulate. For example, some analytical processes include a volatile reagent (e.g., methanol, ethyl alcohol, acetate, etc.) which can evaporate quickly, particularly when used in small volumes and/or with heat. For these reasons, dispensing a volume of volatile reagents (e.g., acetone) can ensure that the intended volume of fluid 106 is deposited on the intended droplet manipulation electrode 108. Other reagents can be susceptible to adsorption (e.g., protein adsorption) or contamination by the surface of the DMF array 110. In these examples, it can be beneficial to deposit these reagents at a time and/or location when they are used in an analytical process.

In an example, the controller 102 can be communicatively coupled to a droplet dispenser 112 to deposit fluid on a DMF array 110 including a plurality of droplet manipulation electrodes 108. As used herein, “communicatively coupled” refers to various wired and/or wireless connections between devices such that data and/or signals may be transferred in various directions between the devices. The controller 102 and/or the computing device 101 can transmit control signals to the droplet dispenser 112 and/or the DMF array 110 related to an operation of the DMF array 110. The controller 102 and/or the computing device 101 can receive information from the DMF array 110, the droplet dispenser 112, the reservoirs 104, and/or the droplet manipulation electrodes 108. In some examples, the controller 102 is to implement an analytical process via the generation of control signals transmitted to at least some of the plurality of droplet manipulation electrodes 108.

For example, the controller 102 can select a first droplet manipulation electrode 108-1 from the plurality of droplet manipulation electrodes 108 on which to dispense a first volume of fluid 106-1 via the droplet dispenser 112. The first volume of fluid 106-1 can be from a first reservoir 104-1. The fluid contained in the first reservoir 104-1 can be a reagent included in an analytical process. The controller 102 and/or the computing device 101 can position the droplet dispenser 112 over the selected first droplet manipulation electrode 108-1 and deposit the first volume of fluid 106-1 onto the selected first droplet manipulation electrode 108-1. In some examples, the controller 102 can cause the DMF array 110 to move to a position under the droplet dispenser 112 such that the droplet dispenser 112 is aligned with the target droplet manipulation electrode (e.g., 108-1). In other examples, the controller 102 and/or the computing device 101 can cause the DMF array 110 and the droplet dispenser 112 to move to a position such that the droplet dispenser 112 is aligned with the target droplet manipulation electrode (e.g., 108-1).

The controller 102 and/or the computing device 101 can detect and/or receive a signal representing a detection from a droplet manipulation electrode 108, As used herein, the term “signal” refers to an electrical indication which can be transmitted and received by the controller 102 and/or the computing device 101. For example, during an analytical process, the first droplet manipulation electrode 108-1 can produce an outcome which can be detected by the controller 102 and/or the computing device 101 as a signal. The controller 102 and/or the computing device 101 can generate a control signal responsive to the outcome produced by the analytical process.

For example, the controller 102 can generate a control signal to cause the droplet dispenser 112 to move to a different position over a second droplet manipulation electrode 108-2 of the plurality of droplet manipulation electrodes 108 responsive to a detection from the first droplet manipulation electrode 108-1. The controller 102 can generate the control signal to move the droplet dispenser 112 to the different position over the second droplet manipulation electrode 108-2 based on the outcome produced by the analytical process. Based on the outcome, the controller 102 and/or the computing device 101 can generate a control signal to cause the droplet dispenser 112 to deposit a second volume of fluid 106-2 onto the second droplet manipulation electrode 108-2. The controller 102 and/or the computing device 101 can, responsive to the detection, cause the first volume of fluid 106-1 on the first droplet manipulation electrode 108-1 to merge with the second droplet manipulation electrode 108-2, wherein the first volume of fluid 106-1 and the second volume of fluid 106-2 are different fluids. The different fluids can be different reagents included in respective reservoirs 104.

As mentioned herein, in some examples, the DMF array 110 uses techniques (e.g., electrowetting) to move volumes of fluid (e.g., the first volume of fluid 106-1) along a particular path on the DMF array 110. For example, the first volume of fluid 106-1 may move from the droplet manipulation electrode 108-1 to merge with a volume of fluid 106-M during an analytical process. The merging of volumes of fluid 106 can allow the volumes of fluid 106 to coalesce to produce an outcome during an analytical process. Based on the outcome of analytical processes, the controller 102 and/or the computing device 101 can determine where to move a volume of fluid 106 and/or whether to position the droplet dispenser 112 and/or the DMF array 110 to deposit a droplet 105 from a reservoir 104. In some examples, the controller 102 and/or the computing device 101 can move the droplet dispenser 112 to align with to a different position absent a detection from the first droplet manipulation electrode 108-1.

For example, the controller 102 and/or the computing device 101 can transmit a control signal to cause the droplet dispenser 112 to move to a different position over a second droplet manipulation electrode 108-2 of the plurality of droplet manipulation electrodes 108 absent a detection from the first droplet manipulation electrode 108-1 and cause the first volume of fluid 106-1 on the first droplet manipulation electrode 108-1 to move to the second droplet manipulation electrode 108-1. In this example, the first droplet manipulation electrode 108-1 may have treated the first volume of fluid 106-1 with an analytical process (e.g., heat, magnetic field, etc.) and, absent a detection, the controller 102 and/or the computing device 101 can move the first volume of fluid 106-1 to the second droplet manipulation electrode 108-2 to continue the analytical process.

For example, the controller 102 can cause the droplet dispenser 112 to deposit a second volume of fluid 106-2 onto the first volume of fluid 106-1 (which has moved to the second droplet manipulation electrode 108-2) on the second droplet manipulation electrode 108-2, wherein the first volume of fluid 106-1 and the second volume of fluid 108-2 are different fluids. In this way, the controller 102 and/or the computing device 101 can dynamically manipulate the volumes of fluid 106. Said differently, an outcome of a first analytical process executed on the first droplet manipulation electrode 108-1 can determine a second analytical process executed on another droplet manipulation electrode 108-2.

While the droplet manipulated electrodes 108-1 and 108-2 were discussed in the examples of FIG. 1, other droplet manipulation electrodes (e.g., 108-N) can be used with other volumes of fluid (e.g., 106-M) during the same period of time. Said differently, a plurality of analytical processes can occur on the DMF array 110 during a time period.

FIG. 1 describes the dynamic use of a droplet dispenser 112 (e.g., a printhead) coupled to a plurality of reservoirs 104 which can respectively contain reagents to be used in analytical processes. Dispensing a droplet 105 from a reservoir 104 included in the droplet dispenser 112 can increase a quantity of analytical processes by dispensing particular reagents from the reservoirs 104.

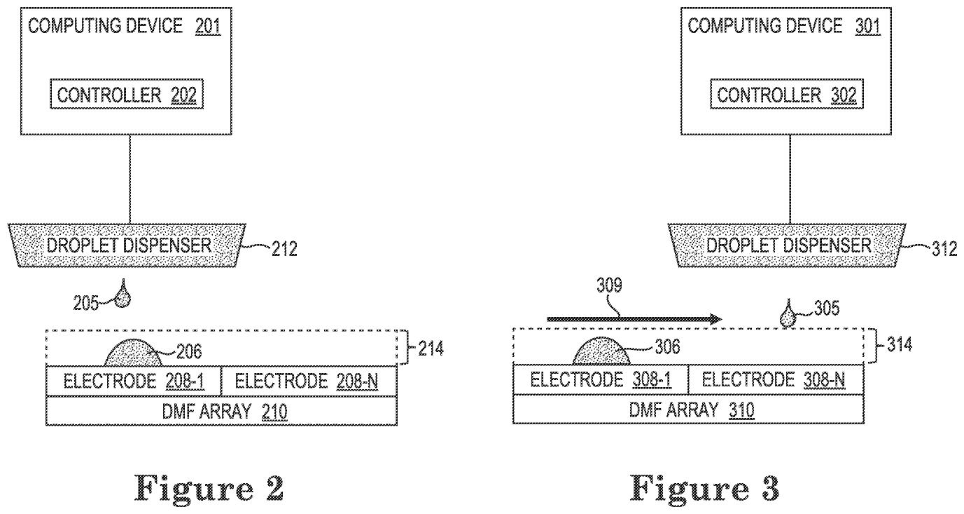

FIG. 2 is an example droplet dispenser 212 and digital microfluidic array 210 for array droplet manipulations consistent with the present disclosure. FIG. 2 illustrates a computing device 201 which can be analogous to the computing device 101 of FIG. 1, coupled to a controller 202 which can be analogous to the controller 202, and a droplet dispenser 212 which can be analogous to the droplet dispenser 112 of FIG. 1. Although not illustrated in FIG. 2 as to not obstruct the examples of the disclosure, the droplet dispenser 212 can include reservoirs (e.g., reservoirs 104 of FIG. 1) containing fluid (e.g., a reagent). The droplet dispenser 212 can dispense a droplet 205, which can be analogous to the droplet 105 of FIG. 1, onto droplet manipulation electrodes 208-1, and 208-N, which can be analogous to droplet manipulation electrodes 108 of FIG. 1, coupled to a DMF array 210 which can be analogous to the DMF array 110 of FIG. 1. A volume of fluid 206, which can be analogous to the volumes of fluid 106 of FIG. 1, can be deposited on a droplet manipulation electrode 208.

Optionally, as illustrated by the broken line, the droplet manipulation electrodes 206 can be covered by a hydrophobic fluid 214. In some examples, the hydrophobic liquid 214 can be an oil (e.g., a mineral oil). In this example, the hydrophobic liquid 214 can reduce the evaporation rate of the droplet 205 and/or the volume of fluid 206, this can allow the size and concentration to stay relatively stable during the testing and evaluation of an analytical process.

The example illustrated by FIG. 2 illustrates a volume of fluid 206 on a droplet manipulation electrode 208-1. The controller 202 and/or the computing device 201 can transmit a control signal to the DMF array 210 to initiate an analytical process on the droplet manipulation electrode 208-1. Based on an outcome of the analytical process, the controller 202 and/or the computing device 201 can align the droplet dispenser 212 to deposit a droplet 205 onto the volume of fluid 206. In some examples, the controller 202 and/or the computing device 201 can refrain from causing the DMF array 210 to move the volume of fluid 206 to a different droplet manipulation electrode (e.g., 208-N). In this example, the droplet manipulation electrode 208-1 may include a functionality (e.g., heat, chemical sensing, etc.) that is different than the functionality of the droplet manipulation electrode 208-N (e.g., magnetic field, droplet partitioning, etc.). Based on the outcome of the analytical process on the droplet manipulation electrode 208-1 the controller 202 and/or the computing device 201 can determine to refrain from moving the volume of fluid 206 to the different droplet manipulation electrode 208-N.

FIG. 3 is an example droplet dispenser 312 and digital microfluidic array 310 for array droplet manipulations consistent with the present disclosure. FIG. 3 illustrates a computing device 301 which can be analogous to the computing device 101 of FIG. 1, coupled to a controller 302 which can be analogous to the controller 302, and a droplet dispenser 312 which can be analogous to the droplet dispenser 112 of FIG. 1. Although not illustrated in FIG. 3 as to not obstruct the examples of the disclosure, the droplet dispenser 312 can include reservoirs (e.g., reservoirs 104 of FIG. 1) containing fluid (e.g., a reagent). The droplet dispenser 312 can dispense a droplet 305, which can be analogous to the droplet 105 of FIG. 1, onto droplet manipulation electrodes 308-1, and 308-N, which can be analogous to droplet manipulation electrodes 108 of FIG. 1, coupled to a DMF array 310 which can be analogous to the DMF array 110 of FIG. 1. A volume of fluid 306, which can be analogous to the volumes of fluid 106 of FIG. 1, can be deposited on a droplet manipulation electrode 308.

Optionally, as illustrated by the broken line, the droplet manipulation electrodes 306 can be covered by a hydrophobic fluid 314. In some examples, the hydrophobic liquid 314 can be an oil (e.g., a mineral oil). In this example, the hydrophobic liquid 314 can reduce the evaporation rate of the droplet 305 and/or the volume of fluid 306, this can allow the size and concentration to stay relatively stable during the testing and evaluation.

The example illustrated by FIG. 3 illustrates a volume of fluid 306 on a droplet manipulation electrode 308-1. The controller 302 and/or the computing device 301 can transmit a control signal to the DMF array 310 to initiate an analytical process on the droplet manipulation electrode 308-1. Based on an outcome of the analytical process, the controller 302 and/or the computing device 301 can align the droplet dispenser 312 to deposit a droplet 305 onto a different droplet manipulation electrode 308-N, where the different droplet manipulation electrode 308-N does not have an existing volume of fluid. The controller 302 and/or the computing device 301 can transmit a control signal to move the volume of fluid 306 onto the different droplet manipulation array 308-N, as indicated by the arrow 309. In this way, the droplet 305 and the volume of fluid 306 can merge. In this example, the droplet manipulation electrode 308-1 may include a functionality (e.g., heat) that is different than the functionality of the droplet manipulation electrode 308-N (e.g., magnetic field). Based on the outcome of the analytical process on the droplet manipulation electrode 308-1 the controller 302 and/or the computing device 301 can determine to move the volume of fluid 306 to the different droplet manipulation electrode 308-N.

FIG. 4 is an example droplet dispenser 412 and digital microfluidic array 410 including a lid 416 for array droplet manipulations consistent with the present disclosure. FIG. 4 illustrates a computing device 401 which can be analogous to the computing device 101 of FIG. 1, coupled to a controller 402 which can be analogous to the controller 402, and a droplet dispenser 412 which can be analogous to the droplet dispenser 112 of FIG. 1. Although not illustrated in FIG. 4 as to not obstruct the examples of the disclosure, the droplet dispenser 412 can include reservoirs (e.g., reservoirs 104 of FIG. 1) containing fluid (e.g., a reagent). The droplet dispenser 412 can dispense a droplet 405, which can be analogous to the droplet 105 of FIG. 1, onto droplet manipulation electrodes 408-1, and 408-N, which can be analogous to droplet manipulation electrodes 108 of FIG. 1, coupled to a DMF array 410 which can be analogous to the DMF array 110 of FIG. 1. A volume of fluid 406, which can be analogous to the volumes of fluid 106 of FIG. 1, can be deposited on a droplet manipulation electrode 408.

The DMF array 410 can be covered by a lid. The lid 414 can be grounded and serve as a grounded electrode. In some examples, the lid 416 can be used intermittently between droplet 405 deposits as with the example DMF arrays 210 and 310 illustrated in connection with FIGS. 2 and 3. In another example, the lid can be perforated.

For example, as illustrated by FIG. 4, the lid 416 includes an aperture 418. As used herein, the term “aperture” refers to an opening through an object such as the lid 416. The aperture can be an opening in the lid such that the droplet 418 can traverse the lid 416.

Optionally, the droplet manipulation electrodes 406 can be covered by a hydrophobic fluid 414. In some examples, the hydrophobic liquid 414 can be an oil (e.g., a mineral oil). In this example, the hydrophobic liquid 414 can reduce the evaporation rate of the droplet 405 and/or the volume of fluid 406, this can allow the size and concentration to stay relatively stable during the testing and evaluation.

The example illustrated by FIG. 4 includes a volume of fluid 406 on a droplet manipulation electrode 408-1. The controller 402 and/or the computing device 401 can transmit a control signal to the DMF array 410 to initiate an analytical process on the droplet manipulation electrode 408-1. Based on an outcome of the analytical process, the controller 402 and/or the computing device 401 can align the droplet dispenser 412 to deposit a droplet 405 onto the volume of fluid 406. In some examples, the controller 402 and/or the computing device 401 can refrain from causing the DMF array 410 to move the volume of fluid 406 to a different droplet manipulation electrode (e.g., 408-N). In this example, the droplet manipulation electrode 408-1 may include a functionality (e.g., heat) that is different than the functionality of the droplet manipulation electrode 408-N (e.g., magnetic field). Based on the outcome of the analytical process on the droplet manipulation electrode 408-1 the controller 402 and/or the computing device 401 can determine to refrain from moving the volume of fluid 406 to the different droplet manipulation electrode 408-N. For example, if the analytical process on the first droplet manipulation electrode did not have an intended result, the controller 402 can determined to add a reagent (e.g., the droplet 405) and attempt the analytical process again.

FIG. 5 is another example droplet dispenser 512 and digital microfluidic array 510 including a lid 516 for array droplet manipulations consistent with the present disclosure. FIG. 5 illustrates a computing device 501 which can be analogous to the computing device 101 of FIG. 1, coupled to a controller 502 which can be analogous to the controller 502, and a droplet dispenser 512 which can be analogous to the droplet dispenser 112 of FIG. 1. Although not illustrated in FIG. 5 as to not obstruct the examples of the disclosure, the droplet dispenser 512 can include reservoirs (e.g., reservoirs 104 of FIG. 1) containing fluid (e.g., a reagent). The droplet dispenser 512 can dispense a droplet 505, which can be analogous to the droplet 105 of FIG. 1, onto droplet manipulation electrodes 508-1, and 508-N, which can be analogous to droplet manipulation electrodes 108 of FIG. 1, coupled to a DMF array 510 which can be analogous to the DMF array 110 of FIG. 1. A volume of fluid 506, which can be analogous to the volumes of fluid 106 of FIG. 1, can be deposited on a droplet manipulation electrode 508.

The DMF array 510 can be covered by a lid. The lid 514 can be grounded and serve as a grounded electrode. In some examples, the lid 516 can be used intermittently between droplet 505 deposits as with the example DMF arrays 210 and 310 illustrated in connection with FIGS. 2 and 3. In another example, the lid can be perforated.

For example, as illustrated by FIG. 5, the lid 516 includes an aperture 518. The aperture can be an opening in the lid such that the droplet 518 can traverse the lid 516. Optionally, the droplet manipulation electrodes 506 can be covered by a hydrophobic fluid 514. In some examples, the hydrophobic liquid 514 can be an oil (e.g., a mineral oil). In this example, the hydrophobic liquid 514 can reduce the evaporation rate of the droplet 505 and/or the volume of fluid 506, this can allow the size and concentration to stay relatively stable during the testing and evaluation.

The example illustrated by FIG. 5 includes a volume of fluid 506 on a droplet manipulation electrode 508-1. The controller 502 and/or the computing device 501 can transmit a control signal to the DMF array 510 to initiate an analytical process on the droplet manipulation electrode 508-1. Based on an outcome of the analytical process, the controller 502 and/or the computing device 501 can align the droplet dispenser 512 to deposit a droplet 505 onto the volume of fluid 506.

In some examples, the volume of fluid 506 can move to the different droplet manipulation electrode 508-N before the droplet 505 traverses the aperture 518 to create a second volume of fluid, The controller 502 and/or the computing device 501 can cause the DMF array 510 to move the volume of fluid 506 to a different droplet manipulation electrode (e.g., 508-N) as illustrated by the arrow 509. In this example, the computing device 501 and/or the controller 502 can cause the volume of fluid 506 on the first droplet manipulation electrode 508-1 to move to the different droplet manipulation electrode 508-N prior to the droplet dispenser 512 depositing the second volume of fluid onto the different droplet manipulation electrode 508-N. In this example, the second volume of fluid can be from the droplet 505 deposited from a different reservoir and traverse the lid 514 to deposit the second volume of fluid onto the first volume of fluid 506 for another analytical process.

In the example illustrated by FIG. 5 the droplet manipulation electrode 508-1 may include a functionality (e.g., heat) that is different than the functionality of the droplet manipulation electrode 508-N (e.g., magnetic field). Based on the outcome of the analytical process on the droplet manipulation electrode 508-1 the controller 502 and/or the computing device 501 can determine to move the volume of fluid 506 to the different droplet manipulation electrode 508-N. For example, if the analytical process on the first droplet manipulation electrode did not have an intended result, the controller 502 and/or the computing device 501 can determined to add a reagent (e.g., the droplet 505) and attempt the analytical process again.

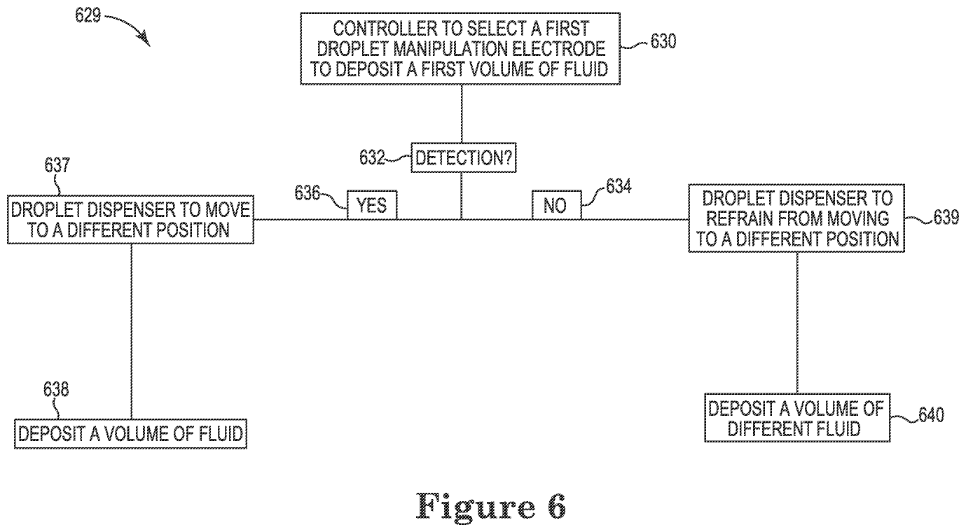

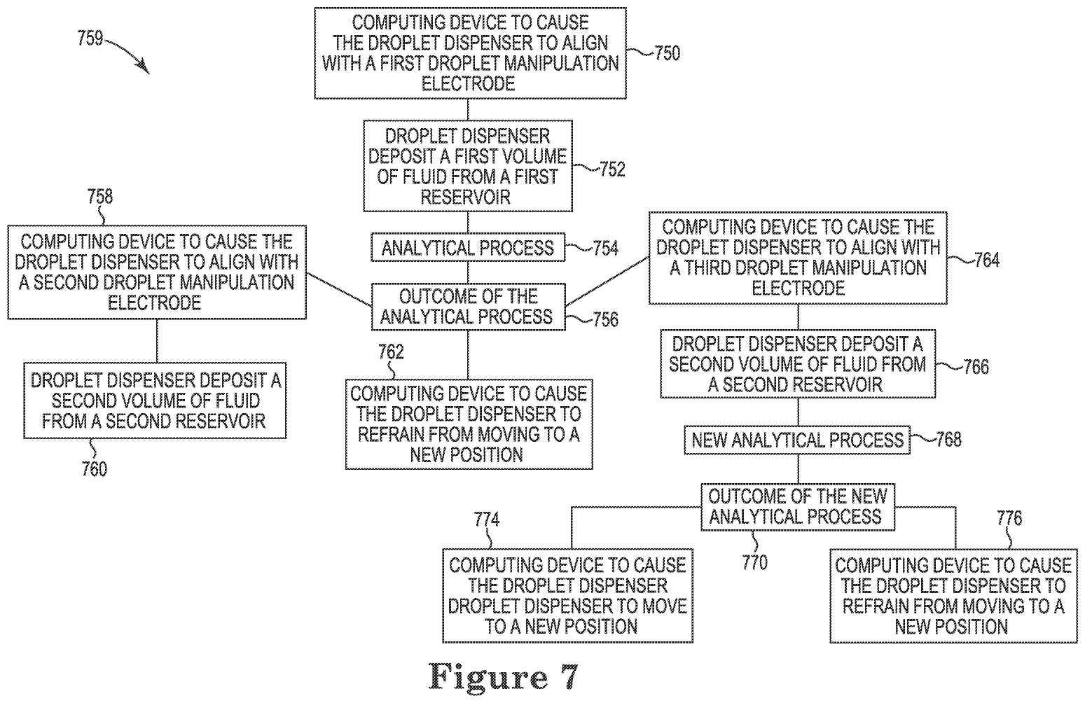

FIG. 6 is a block diagram 629 for array droplet manipulations consistent with the present disclosure. The block diagram 629 describes an example system including a computing device (e.g., the computing device 101 of FIG. 1) including a controller (e.g., the controller 102 of Figure coupled to a DMF array (e.g., the DMF array 110 of FIG. 1) including a plurality of droplet manipulation electrodes (e.g., the droplet manipulation electrodes 108 of FIG. 1) and a droplet dispenser (e.g., the droplet dispenser 112 of FIG. 1). The computing device to cause the droplet dispenser to align with a first droplet manipulation electrode (e.g., the first droplet manipulation electrode 108-1 of FIG. 1) of the plurality of droplet manipulation electrodes.

For example, at block 630, the controller can select a first droplet manipulation electrode to deposit a first volume of fluid (e.g., the first volume of fluid 106-1 of FIG. 1). The controller can generate control signals related to the execution of an analytical process. The controller can select the first droplet manipulation electrode based on the analytical process to be executed. The controller can transmit a control signal to the DMF array to initiate the analytical process of the first volume of fluid deposited on the first droplet manipulation electrode.

At block 632, the controller can determine an outcome of the first analytical process by sensing a detection. For example, the droplet dispenser can be a printhead that is equipped with sensors (e.g., camera, spectrometer, etc.) to detect an outcome of an analytical process. If an outcome is detected (“Yes” at 636) the controller may transmit a control signal to the DMF array to move the first volume of fluid to a second droplet manipulation electrode (e.g., the second droplet manipulation electrode 108-2 of FIG. 1). The controller can transmit a control signal, at block 637, to cause the droplet dispenser to move to a different position such that it can align with the second droplet manipulation electrode. The second droplet manipulation electrode may include a different functionality and/or include an existing volume of fluid to merge with the first droplet of fluid. In this example, the analytical process can continue on the second droplet manipulation electrode.

At block 638, the controller can cause the droplet dispenser to deposit a volume of fluid. The volume of fluid can be from a first reservoir (e.g., the first reservoir 104-1 of FIG. 1) and deposited in response to the droplet dispenser aligning with the second droplet manipulation electrode. The first reservoir is selected by the computing device based on the outcome of the analytical process corresponding to the first volume of fluid deposited on the first droplet manipulation electrode. In some examples, the controller does not sense a detection.

For example, the controller may not sense a detection (“No” at block 634). The controller may transmit a control signal to the DMF array to, refrain from moving the first volume of fluid to a second droplet manipulation electrode (e.g., the second droplet manipulation electrode 108-2 of FIG. 1). The controller can transmit a control signal, at block 639, to cause the droplet dispenser to refrain from moving to a different position such that it can align with the second droplet manipulation electrode. In this example, the controller can initiate another analytical process and/or repeat the initial analytical process. The controller can determine, based on the outcome of the analytical process (“No” at 634), to deposit a volume of a different fluid at block 640. The different fluid can be from a second reservoir (e.g., the second reservoir 104-P of FIG. 1). The second reservoir is selected by the computing device based on the outcome of the analytical process corresponding to the first volume of fluid deposited on the first droplet manipulation electrode

FIG. 6 describes the computing device and/or the controller dynamically aligning the droplet dispenser to a plurality of droplet manipulation electrodes based on an outcome of an analytical process. This can increase a quantity of analytic processes that can be initialed on a DMF array within the same period of time.

FIG. 7 is a block diagram 759 for array droplet manipulations consistent with the present disclosure. The block diagram 759 describes an example system including a computing device (e.g., the computing device 101 of FIG. 1) including a controller (e.g., the controller 102 of Figure coupled to a DMF array (e.g., the DMF array 110 of FIG. 1) including a plurality of droplet manipulation electrodes (e.g., the droplet manipulation electrodes 108 of FIG. 1) and a droplet dispenser (e.g., the droplet dispenser 112 of FIG. 1).

At block 750 the computing device can cause the droplet dispenser to align with a first droplet manipulation electrode (e.g., the first droplet manipulation electrode 108-1 of FIG. 1) of the plurality of droplet manipulation electrodes. As mentioned herein, the droplet dispenser can be a printhead equipped with sensors to align the droplet dispenser with the first droplet manipulation electrode. At block 752, the controller can cause the droplet dispenser to deposit a first volume of fluid 106-1 from a first reservoir 104-1.

For example, a first reservoir of a plurality of reservoirs (e.g., the plurality of reservoirs 104) can be coupled to the droplet dispenser, the droplet dispenser can deposit a first volume of fluid from the first reservoir on the first droplet manipulation electrode responsive to the alignment of the droplet dispenser and the first droplet manipulation electrode.

The controller can generate control signals related to an analytical process. The controller, at block 754, can transmit control signals to initiate the analytical process on the first droplet manipulation electrode. Based on the outcome of the analytical process, the controller can initiate other assay droplet manipulations.

For example, at block 762, the computing device and/or the controller can cause the droplet dispenser to refrain from moving to a new position. The computing device and/or the controller can refrain from moving to the new position because the outcome of the analytical process was not as expected, or, the computing device and/or the controller has determined that no further analytical processes are to be performed on the first volume of fluid.

In another example, the computing device and/or the controller can split the first volume of fluid responsive to the completion of the analytical process at block 756. A portion of the first volume of fluid can be moved by the DMF array to a second droplet manipulation electrode. For example, at block 758, the computing device and/or the controller can cause the droplet dispenser to align with a second droplet manipulation electrode (e.g., the second droplet manipulation electrode 108-2) responsive to an outcome of the analytical process (at block 754) corresponding to the first volume of fluid deposited on the first droplet manipulation electrode.

The computing device and/or the controller can, at block 760, cause the droplet dispenser to deposit a second volume of fluid (e.g., the second volume of fluid 106-2 of FIG. 1) from a second reservoir (e.g., the reservoir 104-P of FIG. 1) onto the second droplet manipulation electrode. In some examples, each reservoir can respectively contain a different reagent, and be selected because a particular reagent is can be used for a subsequent analytical process. For example, a second reservoir can be selected by the computing device and/or the controller based on the outcome of the analytical process corresponding to the first volume of fluid deposited on the first droplet manipulation electrode.

As mentioned, the DMF array can further comprise a lid. In another example, at block 760, the computing device and/or the controller can cause the second volume of fluid deposited from the second reservoir to traverse the lid to deposit the second volume of fluid onto a second droplet manipulation electrode, and the computing device and/or controller can cause the first volume of fluid on the first droplet manipulation electrode to move to the second droplet manipulation electrode to merge with the second volume of fluid on the second droplet manipulation electrode for another analytical process to be initiated.

As mentioned, the computing device and/or the controller can split the first volume of fluid responsive to the completion of the analytical process at block 756. For example, at block 764, the computing device and/or the controller can cause the droplet dispenser to align with a third droplet manipulation electrode (e.g., droplet manipulation electrode 108-N) responsive to an outcome of the analytical process (at block 754) corresponding to the first volume of fluid deposited on the first droplet manipulation electrode.

The computing device and/or the controller can, at block 766, cause the droplet dispenser to deposit a second volume of fluid from a second reservoir onto the third droplet manipulation electrode. For example, the computing device and/or the controller can cause a second reservoir of the plurality of reservoirs coupled to the droplet dispenser to deposit a second volume of fluid from the second reservoir on the third droplet manipulation electrode responsive to the alignment of the droplet dispenser and the third droplet manipulation electrode.

The computing device and/or the controller at block 768 can generate control signals related to the initiation of a new analytical process on the third droplet manipulation electrode. For example, the computing device and/or the controller can initiate a new analytical process corresponding to the second volume of fluid deposited on the third droplet manipulation electrode. The droplet dispenser, at 770, can detect an outcome using sensors coupled to the droplet dispenser.

The computing device and/or the controller can refrain from causing the droplet dispenser to deposit a third volume of fluid from a third reservoir of the plurality of reservoirs responsive to an outcome of the new analytical process. Said differently, the computing device and/or the controller, can end the analytical process. At block 776, the computing device and/or the controller can cause the droplet dispenser to refrain from moving to a new position (e.g., a new droplet manipulation electrode on the DMF array).

Based on the outcome of the new analytical process from block 768, the computing device and/or the controller at block 774 can cause the droplet dispenser to move to a new position. In this example, the computing device and/or the controller can initiate a new analytical process. FIG. 7 describes how the outcomes from analytical processes can determine how a droplet dispenser can deposit volumes of fluid on a DNF array.

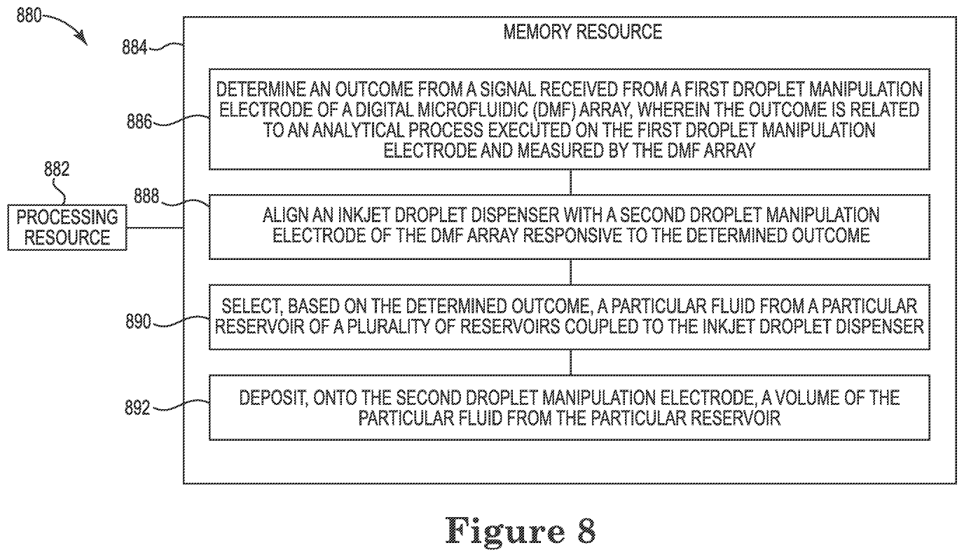

FIG. 8 is an example is a functional diagram representing a processing resource 882 in communication with a memory resource 884 having instructions 886, 888, 890, 892, written thereon for array droplet manipulations consistent with the present disclosure. The processing resource 882, in some examples, can be analogous to the controller 102 describe with respect to FIG. 1.

A system 880 can be a server or a computing device (among others) and can include the processing resource 882. The system 880 can further include the memory resource 884 (e.g., a non-transitory Machine Readable Medium), on which may be stored instructions, such as instructions 886, 888, 890, 892. Although the following descriptions refer to a processing resource and a memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

The memory resource 884 may be electronic, magnetic, optical, or other physical storage device that stores executable instructions. Thus, the memory resource 884 may be, for example, a non-transitory MRM comprising Random Access Memory (RAM), an Electrically-Erasable Programmable ROM (EEPROM), storage drive, an optical disc, and the like. The memory resource 884 may be disposed within a controller and/or computing device. In this example, the executable instructions 886, 888, 890, and 892 can be “installed” on the device. Additionally, and/or alternatively, the memory resource 884 can be a portable, external or remote storage medium, for example, that allows the system 880 to download the instructions 886, 888, 890, and 892 from the portable/external/remote storage medium. In this situation, the executable instructions may be part of an “installation package”. As described herein, the memory resource 884 can be encoded with executable instructions for array droplet manipulations.

The instructions 886, when executed by a processing resource such as the processing resource 882, can include instructions to determine an outcome from a signal received from a first droplet manipulation electrode of a DMF array, wherein the outcome is related to an analytical process executed on the first droplet manipulation electrode and measured by the DMF array. The signal can represent data generated by the analytical process executed on the first droplet manipulation electrode. As mentioned herein, the droplet dispenser can be an inkjet printhead.

The instructions 888, when executed by a processing resource such as the processing resource 882, can include instructions to align an inkjet droplet dispenser with a second droplet manipulation electrode of the DMF array responsive to the determined outcome. The determined outcome could be a result from the analytical process, and/or a phase of an assay with multiple phases. In some examples, the processing resource can execute instructions to initiate another analytical process on the second droplet manipulation electrode.

The instructions 890, when executed by a processing resource such as the processing resource 882, can include instructions to select, based on the determined outcome, a particular fluid from a particular reservoir of a plurality of reservoirs coupled to the inkjet droplet dispenser. The particular fluid can be a reagent for the other analytical process.

The instructions 892, when executed by a processing resource such as the processing resource 882, can include instructions to deposit, onto the second droplet manipulation electrode, a volume of the particular fluid from the particular reservoir. In some examples, the processing resource can further execute instructions to determine the outcome of the other analytical process and refrain from moving the volume of the particular fluid from the second droplet manipulation electrode responsive to the outcome of the other analytical process.

The above specification, examples and data provide a description of the method and applications and use of the system and method of the present disclosure. Since many examples can be made without departing from the scope of the system and method of the present disclosure, this specification merely sets forth some of the many possible example configurations and implementations.

What is claimed:

1. An apparatus, comprising:
a controller communicatively coupled to a droplet dispenser to deposit fluid on a digital microfluidic (DMF) array including a plurality of droplet manipulation electrodes, the controller to:
select a first droplet manipulation electrode from the plurality of droplet manipulation electrodes to on which to dispense a first volume of fluid via the droplet dispenser;
position the droplet dispenser over the selected first droplet manipulation electrode; and
deposit the first volume of fluid onto the selected first droplet manipulation electrode.

2. The apparatus of claim 1, wherein the controller is to:
cause the droplet dispenser to move to a different position over a second droplet manipulation electrode of the plurality of droplet manipulation electrodes responsive to a detection from the first droplet manipulation electrode; and
deposit a second volume of fluid onto the second droplet manipulation electrode.

3. The apparatus of claim 2, wherein the controller is to:
cause the first volume of fluid on the first droplet manipulation electrode to merge with the droplet deposited on the second droplet manipulation electrode, wherein the first volume of fluid and the second volume of fluid are different fluids.

4. The apparatus of claim 1, wherein the controller is to:
cause the droplet dispenser to move to a different position over a second droplet manipulation electrode of the plurality of droplet manipulation electrodes absent a detection from the first droplet manipulation electrode; and
cause the first volume of fluid on the first droplet manipulation electrode to move to the second droplet manipulation electrode.

5. The apparatus of claim 4, wherein the controller is to cause the droplet dispenser to deposit a second volume of fluid onto the first volume of fluid on the second droplet manipulation electrode, wherein the first volume of fluid and the second volume of fluid are different fluids.

6. The apparatus of claim 1, further comprising a plurality of reservoirs coupled to the droplet dispenser, wherein each of the plurality of reservoirs contains a different fluid.

7. The apparatus of claim 1, wherein the controller is to implement an analytical process via the generation of control signals transmitted to at least some of the plurality of droplet manipulation electrodes.

8. A system, comprising:
a computing device coupled to a digital microfluidic (DMF) array including a plurality of droplet manipulation electrodes and a droplet dispenser, the computing device to cause the droplet dispenser to align with a first droplet manipulation electrode of the plurality of droplet manipulation electrodes;
a first reservoir of a plurality of reservoirs coupled to the droplet dispenser, the droplet dispenser to deposit a first volume of fluid from the first reservoir on the first droplet manipulation electrode responsive to the alignment of the droplet dispenser and the first droplet manipulation electrode;
the computing device to cause the droplet dispenser to align with a second droplet manipulation electrode responsive to an outcome of an analytical process corresponding to the first volume of fluid deposited on the first droplet manipulation electrode; and
a second reservoir of the plurality of reservoirs coupled to the droplet dispenser, the droplet dispenser to deposit a second volume of fluid from the second reservoir on the second droplet manipulation electrode responsive to the alignment of the droplet dispenser and the second droplet manipulation electrode.

9. The system of claim 8, wherein the second reservoir is selected by the computing device based on the outcome of the analytical process corresponding to the first volume of fluid deposited on the first droplet manipulation electrode.

10. The system of claim 8, further comprising a lid positioned over the DMF array, wherein:
the second volume of fluid deposited from the second reservoir traverses the lid to deposit the second volume of fluid onto the second droplet manipulation electrode; and
the computing device is to cause the first volume of fluid on the first droplet manipulation electrode to move to the second droplet manipulation electrode to merge with the second volume of fluid on the second droplet manipulation electrode for another analytical process to be initiated.

11. The system of claim 8, further comprising a lid positioned over the DMF array, wherein:
the computing device is to cause the first volume of fluid on the first droplet manipulation electrode to move to the second droplet manipulation electrode prior to the droplet dispenser depositing the second volume of fluid onto the second droplet manipulation electrode; and
the second volume of fluid deposited from the second reservoir traverses the lid to deposit the second volume of fluid onto the first volume of fluid for another analytical process.

12. The system of claim 8, wherein the computing device is to:
initiate a new analytical process corresponding to the second volume of fluid deposited on the second droplet manipulation electrode; and
refrain from causing the droplet dispenser to deposit a third volume of fluid from a third reservoir of the plurality of reservoirs responsive to the outcome of the new analytical process.

13. A non-transitory machine-readable medium comprising a processing resource in communication with a memory resource having instructions executable to:
determine an outcome from a signal received from a first droplet manipulation electrode of a digital microfluidic (DMF) array, wherein the outcome is related to an analytical process executed on the first droplet manipulation electrode and measured by the DMF array;
align an inkjet droplet dispenser with a second droplet manipulation electrode of the DMF array responsive to the determined outcome;
select, based on the determined outcome, a particular fluid from a particular reservoir of a plurality of reservoirs coupled to the inkjet droplet dispenser; and
deposit, onto the second droplet manipulation electrode, a volume of the particular fluid from the particular reservoir.

14. The medium of claim 13, further comprising the instructions executable to initiate another analytical process on the second droplet manipulation electrode.

15. The medium of claim 14, further comprising the instructions executable to:
determine the outcome of the other analytical process; and
refrain from moving the volume of the particular fluid from the second droplet manipulation electrode responsive to the outcome of the other analytical process.
